(19) United States
(12) Patent Application Publication
(10) Pub. No.: US 2021/0252646 A1
(43) Pub. Date: Aug. 19, 2021

(54) Laser cutting system and method

(71) Applicant: NPS CO.,LTD., Cheongju-si (KR)

(72) Inventor: Seong Ho BAE, Daejeon (KR)

(21) Appl. No.: 17/178,124

(22) Filed: Feb. 17, 2021

(30) Foreign Application Priority Data
Feb. 17, 2020 (KR) 10-2020-0018855
Feb. 9, 2021 (KR) 10-2021-0018631

(51) Int. Cl. B23K 26/38; B23K 26/70; B23K 26/03

(52) U.S. Cl. CPC B23K 26/38; B23K 26/032; B23K 26/70

(57) ABSTRACT

The present disclosure relates to a laser cutting system including a processing machine provided to perform laser cutting on a processing target using a laser beam according to a predetermined processing design to divide the processing target to form a product having a shape corresponding to the processing design; a setting module for preparing, according to predetermined processing conditions, a process recipe including a plurality of set values for testing of processing parameters that affect the quality value of laser cutting processing; a controller for repeatedly performing first test cutting processing on the processing target in multiple implementation rounds by driving the processing machine by selectively using any one of the set values for testing as the set value of the processing parameters according to a predetermined order; and an analysis module for analyzing each of results of the first test cutting processing and individually measuring the quality value of each of the results of the first test cutting processing, and selecting, among the set values for testing, a set value for testing used in a specific implementation round of the first test cutting processing, at which the quality value that most satisfies predetermined reference quality is measured, as a set value for mass production of the processing parameters.

### CROSS-REFERENCE TO RELATED APPLICATION

This application claims priority to Korean Patent Application No. 10-2020-0018855, filed on Feb. 17, 2020, and Korean Patent Application No. 10-2021-0018631, filed on Feb. 9, 2021, in the Korean Intellectual Property Office, the disclosure of which is incorporated herein by reference.

### BACKGROUND OF THE DISCLOSURE

### Field of the Disclosure

The present disclosure relates to a laser cutting system and a laser cutting method.

### Description of the Related Art

In general, in laser cutting processing, the laser cutting quality of a processing target can be controlled by changing the set values of processing parameters, such as the power, frequency, pulse width, duty ratio, and focal length of a laser beam and the pressure of an assist gas, that affect laser cutting quality.

Conventionally, an operator manually changes the set values of processing parameters to control the laser cutting quality of a processing target according to the material and shape of the processing target, a processing purpose, and the like. As such, in the related art, since an operator controls laser cutting quality by manually changing the set values of processing parameters, there is a problem in that laser cutting quality and time and cost required to control the laser cutting quality significantly depend on the number of operators and the skill of the operators.

### SUMMARY OF THE DISCLOSURE

Therefore, the present disclosure has been made in view of the above problems, and it is an object of the present disclosure to provide an improved laser cutting system and an improved laser cutting method that are capable of automatically performing an operation of controlling laser cutting quality.

It is another object of the present disclosure to provide an improved laser cutting system and an improved laser cutting method that are capable of reducing time required to control laser cutting quality.

In accordance with one aspect of the present disclosure, provided is a laser cutting system including a processing machine provided to perform laser cutting on a processing target using a laser beam according to a predetermined processing design to divide the processing target to form a product having a shape corresponding to the processing design; a setting module for preparing, according to predetermined processing conditions, a process recipe including a plurality of set values for testing of processing parameters that affect a quality value of laser cutting processing; a controller for repeatedly performing first test cutting processing on the processing target in multiple implementation rounds by driving the processing machine by selectively using any one of the set values for testing as a set value of the processing parameters according to a predetermined order; and an analysis module for analyzing each of results of the first test cutting processing and individually measuring a quality value of each of the results of the first test cutting processing, and selecting, among the set values for testing, a set value for testing used in a specific implementation round of the first test cutting processing, at which the quality value that most satisfies predetermined reference quality is measured, as a set value for mass production of the processing parameters.

Preferably, the laser cutting system further includes an input module provided to input at least one of the processing design and the reference quality.

Preferably, the setting module sets the set values for testing according to predetermined setting criteria, wherein the setting criteria include a minimum set value that is a smallest absolute value among the set values for testing, a maximum set value that is a largest absolute value among the set values for testing, and a unit interval of the set values for testing.

Preferably, the input module is provided to input at least one of the minimum set value, the maximum set value, and the unit interval.

Preferably, when the reference quality is a reference quality value, the analysis module selects, among the set values for testing, a set value for testing used in a specific implementation round of the first test cutting processing, at which the quality value having a smallest error based on the reference quality value is measured, as the set value for mass production, and when the reference quality is within a reference quality range, the analysis module selects, among the set values for testing, a set value for testing used in a specific implementation round of the first test cutting processing, at which the quality value having a smallest error based on a median of the reference quality range is measured, as the set value for mass production.

Preferably, when a rectangular product having a predetermined width and length is manufactured, a processing shape of the processing design is defined by a cutting line forming a rectangular closed loop that matches an outline of the product, the setting module divides the processing design into a plurality of processing units each including any one of a plurality of unit linear sections constituting the cutting line, the controller selectively performs first test cutting processing on a specific processing unit among the processing units, and the analysis module analyzes results of the first test cutting processing for the specific processing unit and selects a common set value for mass production for the processing units.

Preferably, the controller drives the processing machine by selectively using the common set value for mass production for the processing units to perform second test cutting processing on the processing units, and the analysis module analyzes results of the second test cutting processing for each of the processing units; individually measures a quality value for each of the processing units; and individually determines whether each of the processing units is defective.

Preferably, the analysis module determines that a processing unit having a quality value satisfying the reference quality among the processing units is good, and determines that a processing unit having a quality value that does not satisfy the reference quality among the processing units is defective.

Preferably, the analysis module reselects a new set value for mass production from the process recipe for the processing unit that has been determined to be defective among the processing units, and the controller applies the new set value for mass production to the processing unit determined to be defective, instead of the previously selected set value for mass production, and performs the second test cutting processing on the processing units again.

Preferably, the setting module inputs a quality value of each of results of the first test cutting processing to the process recipe so that the quality value matches the set value for testing used at a specific implementation round of the first test cutting processing at which the quality value is measured, and when there is the processing unit that has been determined to be defective, the analysis module reselects, as the new set value for mass production for the processing unit that has been determined to be defective, a quality value satisfying reference quality as a next rank of a quality value matching a set value for testing previously selected as the set value for mass production among the quality values.

Preferably, the setting module prepares the process recipe so that a set value for testing of each of a plurality of processing parameters for controlling the quality value is individually included.

Preferably, when the first test cutting processing is performed, for each of remaining processing parameters except for a specific processing parameter among the processing parameters, the controller uses a predetermined default set value as a set value of each of the remaining processing parameters, and selectively uses any one set value for testing among set values for testing of the specific processing parameter as a set value of the specific processing parameter, and the analysis module identifies which of the processing parameters is associated with the set value for mass production when results of the first test cutting processing are analyzed and the set value for mass production is selected.

Preferably, when the second test cutting processing is performed, the controller uses the set value for mass production as a set value of a specific processing parameter associated with the set value for mass production among the processing parameters, and uses a predetermined default set value of each of the remaining processing parameters as a set value of each of remaining processing parameters except for the specific processing parameter.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 schematically illustrates the configuration of a laser cutting system according to a preferred embodiment of the present disclosure;

FIG. 2 is a top view of the laser cutting system shown in FIG. 1;

FIG. 3 is a block diagram for explaining control of the laser cutting system shown in FIG. 1;

FIG. 4 is a drawing for explaining the concept of kerf width;

FIG. 5 is a flowchart for explaining a laser processing method using a laser cutting system;

FIG. 6 is a drawing for explaining a method of setting the processing design of a processing target and the reference quality of quality items;

FIG. 7 is a drawing for explaining a method of preparing setting criteria for processing parameters;

FIG. 8 is a drawing for explaining a method of dividing a processing design into a plurality of processing units;

FIG. 9 is a drawing for explaining a method of preparing a process recipe;

FIG. 10 is a drawing for explaining a method of performing first test cutting processing on a processing target using set values for testing included in a process recipe;

FIG. 11 is a drawing for explaining a method of selecting a set value for mass production among set values for testing included in a process recipe using the results of first test cutting processing;

FIG. 12 is a drawing for explaining a method of performing second test cutting processing on a processing target using a set value for mass production selected from a process recipe;

FIG. 13 is a drawing for explaining a method of performing second test cutting processing once more using a set value for mass production reselected according to the results of second test cutting processing; and

FIG. 14 is a drawing for explaining a method of obtaining the dimension information and angle information of a product.

### DETAILED DESCRIPTION OF THE DISCLOSURE

Hereinafter, the embodiments of the present disclosure will be described in detail with reference to the attached drawings. Here, when reference numerals are applied to constituents illustrated in each drawing, it should be noted that like reference numerals indicate like elements throughout the specification. In addition, in the following description of the present disclosure, a detailed description of known functions and configurations incorporated herein will be omitted when it may make the subject matter of the present disclosure unclear.

In describing the components of the embodiments of the present disclosure, terms such as first, second, A, B, (a), and (b) may be used. These terms are used to distinguish each component from other components, and the nature or order of the components is not limited by these terms. In addition, unless defined otherwise, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

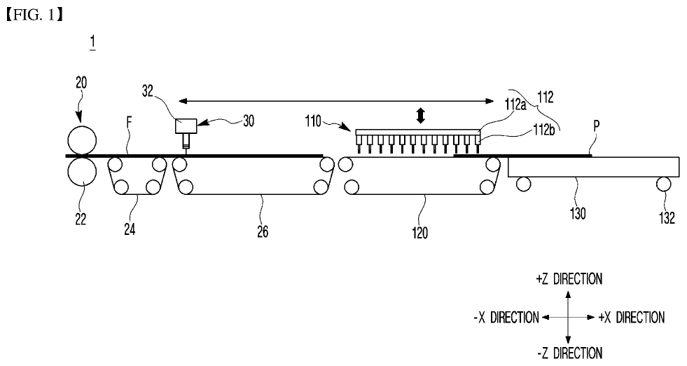

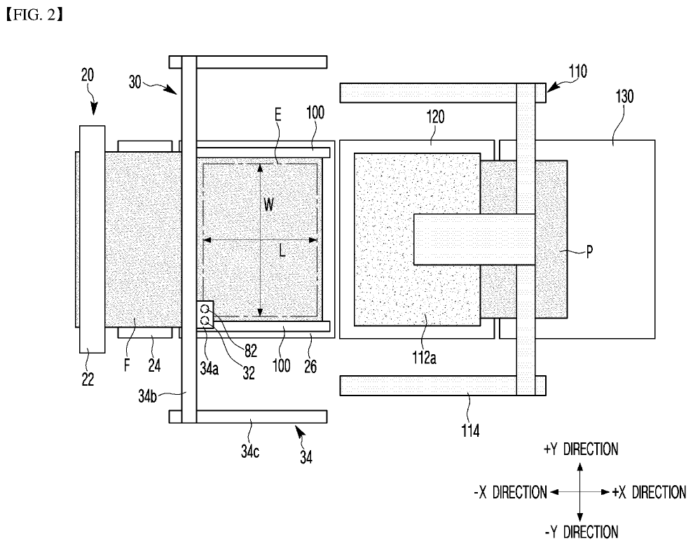

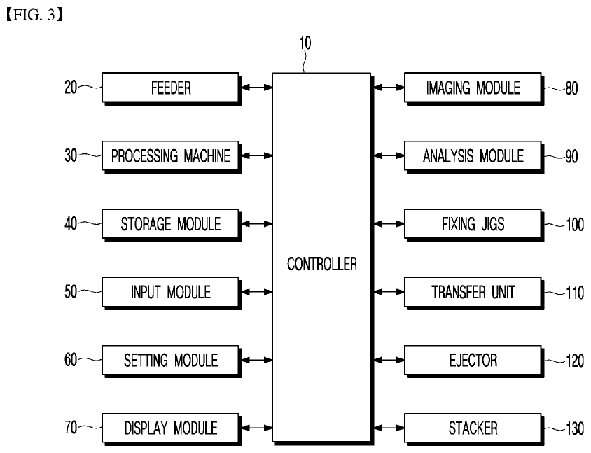

FIG. 1 schematically illustrates the configuration of a laser cutting system according to a preferred embodiment of the present disclosure, FIG. 2 is a top view of the laser cutting system shown in FIG. 1, and FIG. 3 is a block diagram for explaining control of the laser cutting system shown in FIG. 1.

Referring to FIGS. 1 to 3, a laser cutting system 1 according to a preferred embodiment of the present disclosure may include a controller 10 for controlling overall operation of the laser cutting system 1, a feeder 20 for feeding a processing target F, a processing machine 30 for performing laser cutting processing on the processing target F using a laser beam (LB), a storage module 40 for storing data for controlling laser cutting quality and various data about the laser cutting system 1, an input module 50 provided to input data about a processing design D, data for controlling laser cutting quality, and various data about the laser cutting system 1, a setting module 60 for preparing a process recipe for selectively driving the laser cutting system 1 so that the quality values of quality items representing laser cutting quality satisfy predetermined reference quality, a display module 70 for displaying the driving state of the laser cutting system 1 and various data about the laser cutting system 1 as images, an imaging module 80 for photographing the laser processing result of the processing target F, and an analysis module 90 for analyzing a captured image of the laser processing result photographed by the imaging module 80 and measuring the laser cutting quality of the processing target F.

The type of the processing target F that may be laser-processed using the laser cutting system 1 is not particularly limited. For example, the processing target F may be a polarizing film fabric for application to a large-area display panel. In this case, using the laser cutting system 1, the processing target F composed of a polarizing film fabric may be subjected to laser cutting processing to obtain a polarizing film sheet having a predetermined width (W) and length (L) as a product P. Hereinafter, the present disclosure will be described on the basis of a case of producing the product P composed of a polarizing film sheet by performing laser cutting processing on the processing target F composed of a polarizing film fabric.

First, as shown in FIGS. 1 and 2, the feeder 20 may include feed rollers 22 that intermittently feed the processing target F along a predetermined conveying direction by a predetermined pitch length, a feed conveyor 24 that conveys the processing target F fed from the feed rollers 22 in the conveying direction and feeds the processing target F to the processing machine 30, and a mounting member 26 on which the processing target F fed to the processing machine 30 by the feed conveyor 24 is mounted. The conveying direction of the processing target F is not particularly limited. For example, the conveying direction may be the length direction of the processing target F.

Hereinafter, for convenience of explanation, the length direction of the processing target F, i.e., the conveying direction of the processing target F, is referred to as the “X direction”, the width direction of the processing target F perpendicular to the length direction of the processing target F is referred to as the “Y direction”, and the thickness direction of the processing target F is referred to as the “Z direction”.

In addition, the structure of the mounting member 26 is not particularly limited. For example, the mounting member 26 may be a conveyor device configured so that the processing target F fed by the feed conveyor 24 is conveyed in the X direction and is disposed at a predetermined processing position. In this case, the processing position refers to a position where laser cutting processing using the processing machine 30 is performed.

Next, as shown in FIG. 2, the processing machine 30 may include a laser oscillator (not shown) for generating and oscillating a laser beam (LB), a laser head 32 for laser cutting the processing target F by radiating a laser beam (LB) oscillated from the laser oscillator onto a region of the processing target F disposed at a predetermined processing position, and a conveying member 34 for moving the laser head 32 in at least one of the X and Y directions in a reciprocating manner In addition, between the laser oscillator and the laser head 32, at least one reflection mirror may be installed to reflect a laser beam (LB) oscillated from the laser oscillator and transmit the laser beam (LB) to the laser head 32.

The configuration of a conveying member 34 is not particularly limited. For example, the conveying member 34 may include a slider 34a to which the laser head 32 is coupled, a first conveying member 34b for moving the slider 34a and the laser head 32 coupled to the slider 34a in the Y direction in a reciprocating manner, and second conveying members 34c for moving the first conveying member 34b and the slider 34a and the laser head 32 coupled to the first conveying member 34b in the X direction in a reciprocating manner In particular, a camera 82 included in the imaging module 80 and responsible for photographing the processing target F being laser-cut by a laser beam (LB) emitted from the laser head 32 may be coupled to the slider 34a so that the camera 82 is spaced apart from the laser head 32 by a predetermined distance. With this configuration, the laser head 32 and the camera 82 may be simultaneously conveyed by the conveying member 34.

While the laser head 32 and the camera 82 are conveyed by the conveying member 34, the laser head 32 may radiate a laser beam (LB) onto the processing target F, and the camera 82 may photograph the processing target F being laser-cut. For example, as shown in FIG. 2, the laser head 32 and the camera 82 may be conveyed by the controller 10 and the conveying member 34 so that the laser head 32 radiates a laser beam (LB) onto the processing target F along a predetermined cutting line E to form the product P from the processing target F and the camera 82 photographs the processing target F being laser-cut along a cutting line E.

In addition, the laser cutting system 1 may further include fixing jigs 100 for fixing the processing target F when laser cutting is performed on the processing target F, a transfer unit 110 for recovering the product P formed by the processing machine 30 from the mounting member 26, an ejector 120 for ejecting the product P recovered by the transfer unit 110, and a stacker 130 on which the product P ejected from the ejector 120 is loaded.

The fixing jigs 100 are configured so as to press, in the Z direction, the end of a region of the processing target F mounted on the mounting member 26 when laser cutting is performed on the processing target F. The number of the fixing jigs 100 is not particularly limited. For example, as shown in FIG. 2, the laser cutting system 1 may include a pair of fixing jigs 100 each configured to fix either end of both sides of the processing target F.

The transfer unit 110 is installed to be spaced apart from the mounting member 26 by a predetermined distance in the X direction. The structure of the transfer unit 110 is not particularly limited. For example, as shown in FIGS. 1 and 2, the transfer unit 110 may include a gripping member 112 for gripping the product P and a conveying member 114 for moving the gripping member 112 in the X direction along the section between the mounting member 26 and the ejector 120 in a reciprocating manner. As shown in FIGS. 1 and 2, the gripping member 112 may include a base plate 112a coupled to the conveying member 114 and one or more vacuum adsorption pads 112b installed on the bottom surface of the base plate 112a to face the product P and configured to grip the product P through vacuum adsorption.

The transfer unit 110 may recover, from the mounting member 26, the product P formed from the processing target F by the processing machine 30 and may mount the product P on the ejector 120.

The ejector 120 is installed to be spaced apart from the mounting member 26 by a predetermined distance in the X direction. The ejector 120 is configured to eject the product P received from the transfer unit 110 along a predetermined ejection path. For example, as shown in FIG. 2, the ejector 120 may be a conveyor device configured to convey the product P mounted on the upper surface of the transfer unit 110 in the X direction and eject the product P.

To receive the product P ejected in the X direction from the ejector 120, the stacker 130 is installed to be spaced apart from the ejector 120 by a predetermined distance in the X direction. As shown in FIG. 1, the stacker 130 preferably has a transport cart structure having wheels 132 so that the products P loaded on the stacker 130 are transported to the outside, but the present disclosure is not limited thereto.

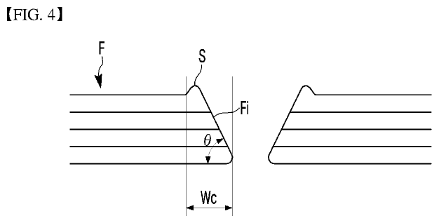

FIG. 4 is a drawing for explaining the concept of kerf width.

Among various quality items representing the laser cutting quality of the processing target F, the type of quality item, the quality degree of which may be controlled using the laser cutting system 1, is not particularly limited. For example, the quality items may include kerf width, and the quality degree of the quality item may be controlled using the laser cutting system 1.

As shown in FIG. 4, in the case of performing laser cutting processing, a kerf width Wc refers to the width of a tapered surface Fi constituting the cutting surface of the processing target F, but the present disclosure is not limited thereto.

In general, when laser cutting processing is performed, since the processing target F is cut so that the cutting surface thereof is inclined, the cutting surface of the processing target F is composed of the tapered surface Fi, and a shoulder S which is generated due to thermal deformation of the processing target F by the laser beam LB is formed at the upper portion of the tapered surface Fi.

In general, the quality of laser cutting processing is associated with the inclination angle (θ) of the tapered surface Fi. In addition, the inclination angle (θ) of the tapered surface Fi is substantially proportional to the width Wc of the tapered surface Fi, i.e., the distance between one end of the tapered surface Fi and the other end of the tapered surface Fi in the horizontal direction of the processing target F. Accordingly, the kerf width Wc may be a quality item representing the quality of laser cutting processing.

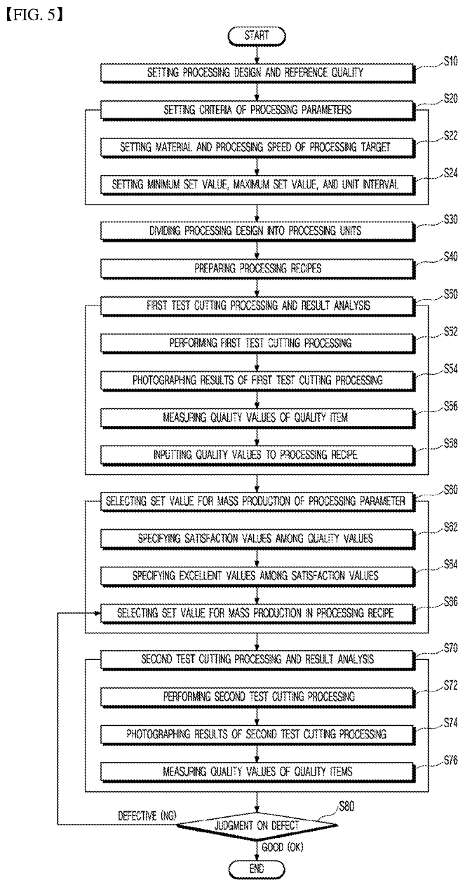

FIG. 5 is a flowchart for explaining a laser processing method using a laser cutting system.

Referring to FIG. 5, the laser processing method using the laser cutting system 1 may include step S10 of setting reference quality for the processing design D and the predetermined quality item of the processing target F, respectively; step S20 of individually setting the setting criteria of each of processing parameters for controlling the quality value of the predetermined quality item according to reference quality; step S30 of dividing, according to the entire processing shape of the processing design D, the processing design D into a plurality of processing units U having identical or different processing shapes; step S40 of preparing a process recipe including the set value for testing of each of the processing parameters generated according to the setting criteria of each of the processing parameters; step S50 of performing first test cutting processing of the processing target F by driving the processing machine 30 by selectively using set values for testing included in the process recipe and analyzing results R1 of the first test cutting processing; step S60 of selecting a set value for mass production of the product P among set values for testing based on the analysis of the results R1 of the first test cutting processing; step S70 of performing second test cutting processing of the processing target F by driving the processing machine 30 by selectively using set values for mass production and analyzing the results R2 of the second test cutting processing; and step S80 of determining, based on the analysis of the results R2 of the second test cutting processing, whether the results R2 of the second test cutting processing are defective.

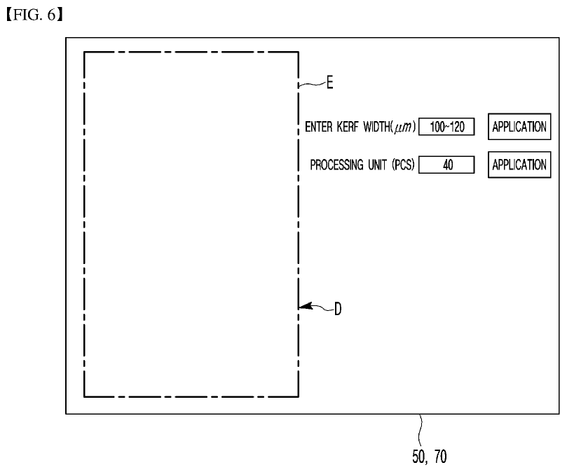

FIG. 6 is a drawing for explaining a method of setting the processing design of a processing target and the reference quality of quality items.

In step S10, the processing design D of the processing target F and the reference quality of predetermined quality items are set.

First, the processing design D of the processing target F to be laser-processed is set. The processing design D of the processing target F corresponds to the design of the product P manufactured by performing laser processing on the processing target F, and may be provided to have a processing shape corresponding to the shape of the product P to be manufactured using the processing target F. For example, as shown in FIG. 6, in the case of manufacturing a polarizing film sheet by performing laser cutting processing on the processing target F, the processing design D may be set to have a rectangular shape having a predetermined width and length corresponding to the width and length of a display panel.

In addition, a method of setting the processing design D is not particularly limited. For example, an operator may set the processing design D by manually inputting the processing design D to the storage module 40 or the setting module 60 using the input module 50, or by uploading design data previously stored in the storage module 40 to the setting module 60.

In general, the processing target F has a variation in thickness for each position due to a tolerance in a manufacturing process. In addition, the fixing jigs 100 have a variation in flatness for each position due to a tolerance in a manufacturing process and deformation due to long-term use.

Due to a variation in thickness of the processing target F and a variation in flatness of the fixing jigs 100, a variation in thickness or flatness may occur in the processing target F during laser cutting processing. Thus, in the case of performing laser cutting processing on the processing target F while keeping the set values of processing parameters constant, laser cutting quality may be different for each area of the processing target F. Accordingly, preferably, laser cutting processing of the processing target F and measurement of laser cutting quality are individually performed for each area of the processing target F.

However, as shown in FIG. 6, the processing shape of the processing design D may be defined by the cutting line E formed to match the outline of the product P to be manufactured by performing laser cutting processing on the processing target F. As shown in FIG. 4, after setting the cutting line E on a region of the processing target F arranged at a predetermined processing position by the feed conveyor 24 and the mounting member 26, laser cutting may be performed on the processing target F according to the processing shape of the processing design D by radiating a laser beam (LB) along the set cutting line E to form the product P from the processing target F.

In addition, the processing design D may be divided into a plurality of processing units U each including a predetermined section among the entire section of the cutting line E. In this case, laser cutting processing and measurement of laser cutting quality may be individually performed for each of the processing units U, thereby improving the laser cutting quality of the laser cutting system 1.

The number of the processing units U is not particularly limited. The number of the processing units U may be determined depending on processing conditions such as a material constituting the processing target F and the processing shape and area of the processing design D.

A method of inputting the number of the processing units U is not particularly limited. For example, an operator may set the number of the processing units U by inputting the number of the processing units U to the storage module 40 or the setting module 60 using the input module 50, or by uploading data about the number of the processing units U previously stored in the storage module 40 to the setting module 60. The processing units U will be described in more detail later.

Next, among quality items, the reference quality of a specific quality item for controlling the degree of quality, i.e., quality value, using the laser cutting system 1 is set. The reference quality refers to a reference quality value or a range of reference quality values indicating that the laser cutting quality for the specific quality item is good, but the present disclosure is not limited thereto. For example, as shown in FIG. 6, when laser cutting quality of kerf width is controlled using the laser cutting system 1, reference quality may be a reference kerf width value or a range of a reference kerf width values indicating that laser cutting quality of kerf width is good.

A method of setting reference quality is not particularly limited. For example, an operator may set reference quality by manually inputting reference quality to the storage module 40 or the setting module 60 using the input module 50, or by uploading quality data previously stored in the storage module 40 to the setting module 60.

In addition, the structure of the input module 50 is not particularly limited. For example, the input module 50 may include a touchscreen for displaying the driving state of the laser cutting system 1 and various other data as images and inputting the control signals of the laser cutting system 1 and various other data. In this case, the input module 50 may function as the display module 70.

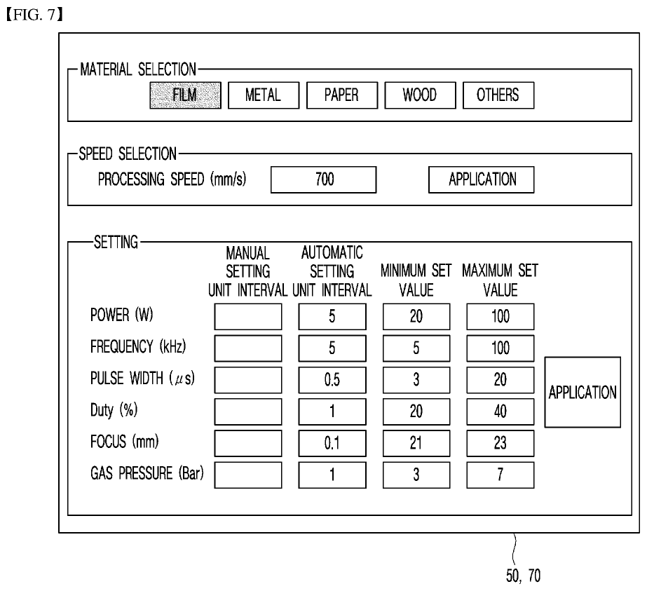

FIG. 7 is a drawing for explaining a method of preparing setting criteria for processing parameters.

In step S20, the setting criteria of each of the processing parameters of the laser cutting system 1 are set according to reference quality.

In general, the laser processing status of the processing target F may be different depending on the material and the processing speed of the processing target F. Accordingly, as shown in FIG. 7, prior to setting the setting criteria for each of processing parameters, it is preferably for an operator to preferentially set the material and the processing speed of the processing target F (step S22).

A method of setting the material and the processing speed of the processing target F is not particularly limited. For example, an operator may set the material and the processing speed of the processing target F by manually inputting the material and the processing speed of the processing target F to the storage module 40 or the setting module 60 using the input module 50, or by uploading data about the material and the processing speed of the processing target F previously stored in the storage module 40 to the setting module 60. When first and second test cutting processing to be described later are performed, the controller 10 may selectively drive the processing machine 30 based on at least one of the material and the processing speed of the processing target F set according to the above manner, thereby improving laser cutting quality.

In addition, the processing parameters refer to various factors, such as factors for the characteristics of a laser beam (LB) and factors for a laser processing environment, that may affect laser cutting quality. Accordingly, to selectively control the quality value of a specific quality item for which reference quality is set in step S10, among various processing parameters of the laser cutting system 1, an operator may selectively set the setting criteria of each of variable parameters that affect the quality value of the specific quality item for which reference quality is set in step S10 (step S24).

For example, when reference quality for kerf width is set in step S10, processing parameters may include the power (W), frequency (kHz), pulse width (μs), duty ratio (%), and focal length (mm) of a laser beam (LB), the pressure (bar) of assist gas, and the like. Here, the assist gas is a gas that is sprayed at a processing point irradiated with a laser beam (LB) during laser processing, and may separate, from the processing point, materials melted, decomposed, and evaporated by a laser beam (LB). Preferably, the assist gas is an inert gas, but the present disclosure is not limited thereto.

Content included in the setting criteria for each of processing parameters is not particularly limited. For example, the setting criteria for each of processing parameters may include a minimum set value (Min), a maximum set value (Max), and a unit interval.

The minimum set value (Min) may correspond to a set value for testing having the smallest absolute value among the set values for testing of processing parameters included in a process recipe. On the other hand, the maximum set value (Max) may correspond to a set value for testing having the largest absolute value among the set values for testing of processing parameters included in a process recipe. The minimum set value (Min) and the maximum set value (Max) may be used to determine the setting range of set values for testing.

In addition, operation data for various operations previously performed using the laser cutting system 1 may be stored in the storage module 40 in an accumulative manner. Thus, the setting module 60 compares at least one of the processing design D and the reference quality that have been set in step S10 and the material and the processing speed of the processing target F (hereinafter referred to as “processing conditions”) that have been set in step S20 with operation data accumulated in the storage module 40.

In addition, based on these comparison results, the setting module 60 may set the minimum set value (Min) and the maximum set value (Max) of each of processing parameters. However, the present disclosure is not limited thereto, and an operator may manually input at least one of the minimum set value (Min) and the maximum set value (Max) of each of processing parameters to the storage module 40 or the setting module 60 using the input module 50.

The unit interval corresponds to the setting interval of the set values for testing of processing parameters included in a process recipe. Accordingly, the number of set values for testing included in a process recipe to be described later is determined according to the absolute value of a unit interval, and thus the number of set values for testing may be controlled by adjusting the unit interval.

The setting module 60 may derive the unit interval of each of processing parameters based on operation data accumulated in the storage module 40 so that an appropriate number of set values for testing is included in a process recipe (see automatic setting unit interval of FIG. 7). However, the present disclosure is not limited thereto, and an operator may set the unit interval for each of processing parameters by manually inputting the unit interval for each of processing parameters to the storage module 40 or the setting module 60 using the input module 50 (see manual setting unit interval of FIG. 7). For example, upon determining that the number of set values for testing included in a process recipe is too large, an operator may manually reset a unit interval to reduce the number of set values for testing to an appropriate level.

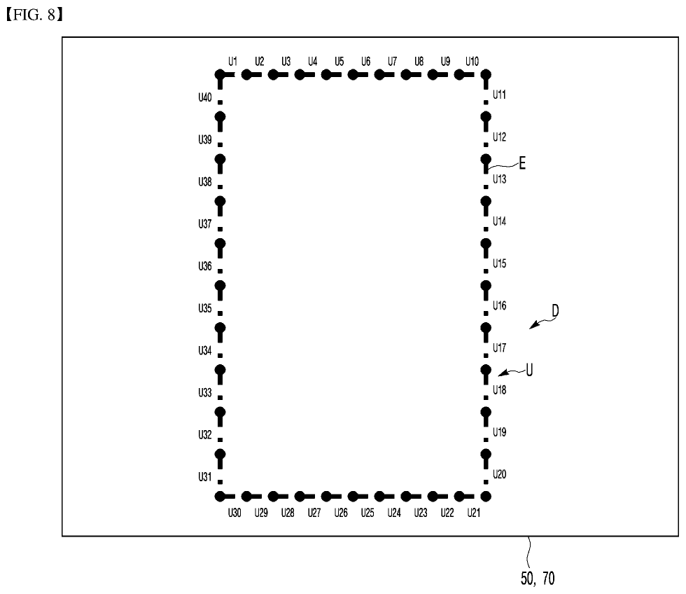

FIG. 8 is a drawing for explaining a method of dividing a processing design into a plurality of processing units.

In step S30, the setting module 60 divides the processing design D into the processing units U according to the processing shape of the processing design D and the number of the processing units U set in step S10.

In general, since a display panel has a rectangular shape, it is preferable that a polarizing film sheet for application to such a display panel also has a rectangular shape. Accordingly, when a polarizing film sheet is manufactured by performing laser cutting processing on the processing target F, the cutting line E may be set to form a rectangular closed loop having the same width and length as those of the polarizing film sheet so that the cutting line E matches the outline of the polarizing film sheet. In this case, as shown in FIG. 8, the setting module 60 may divide the cutting line E into a plurality of unit linear sections each having a predetermined length.

In addition, the setting module 60 may divide the processing design D into the processing units U each including any one of unit linear sections, and then store the processing design D in the storage module 40. Then, when the product P is manufactured, the processing unit U is laser-cut into a straight line along a unit linear section included in the processing unit U, and the processing units U have the same processing shape.

In addition, the length of the unit linear section is not particularly limited, and the unit linear sections may have the same length or different lengths.

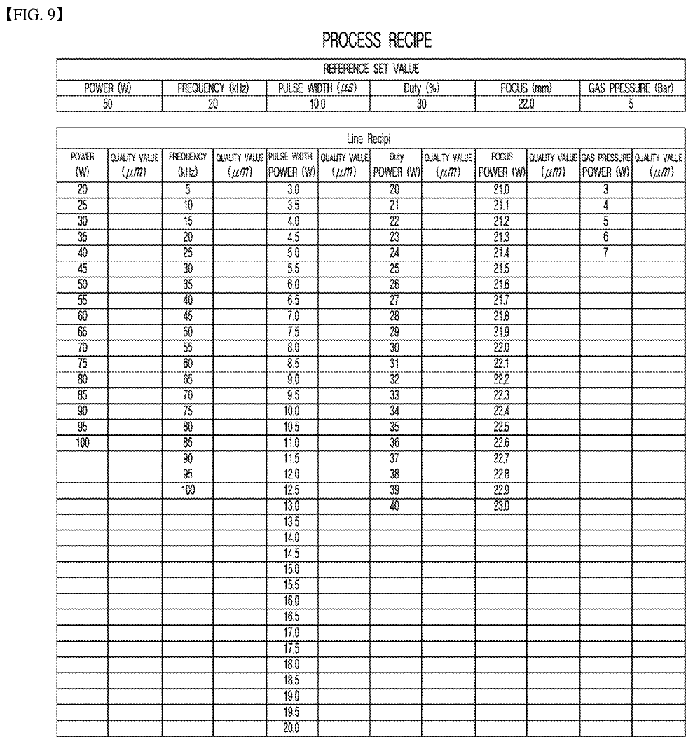

FIG. 9 is a drawing for explaining a method of preparing a process recipe.

In step S40, the setting module 60 may prepare a process recipe for laser processing of the processing target F according to the setting criteria of each of processing parameters set in step S20, and then may store the process recipe in the storage module 40.

The process recipe refers to a data table in which the set value for testing of each of processing parameters is stored in a table format. The set value for testing of each of processing parameters is the set value of each of processing parameters for performing first test cutting processing of the processing target F to be described later, and is set according to setting criteria set in above-described step S20. Accordingly, the set value for testing of each of processing parameters may include at least a minimum set value and a maximum set value. In this case, the set values may be set so that an absolute value is incrementally increased by a unit interval from the minimum set value to the maximum set value. The number of set values for testing included in the process recipe may be determined according to the minimum set value, the maximum set value, and the unit interval of each of the processing parameters.

The number of the process recipes is not particularly limited, and at least one process recipe may be prepared according to the processing shape of the processing units U. For example, in the case of manufacturing a rectangular polarizing film sheet by performing laser cutting processing on the processing target F, the processing units U have the same processing shape, and thus a single process recipe may be prepared.

In addition, as shown in FIG. 9, in a process recipe, the default set value of each of processing parameters may be additionally input. The default set value refers to a set value for testing that is expected to satisfy the reference quality of predetermined quality items when laser processing is performed according to the set value for testing among set values for testing. Preferably, the default set value is individually set for each process recipe, but the present disclosure is not limited thereto.

A method of inputting default set values is not particularly limited. For example, the setting module 60 may compare the processing conditions and the processing shape of each of the processing units U with operation data accumulated in the storage module 40, may individually deduce the default set value of each of processing parameters for each process recipe, and may input the deduced default set value to each process recipe. However, the present disclosure is not limited thereto, and an operator may manually input a default set value to a process recipe using the input module 50.

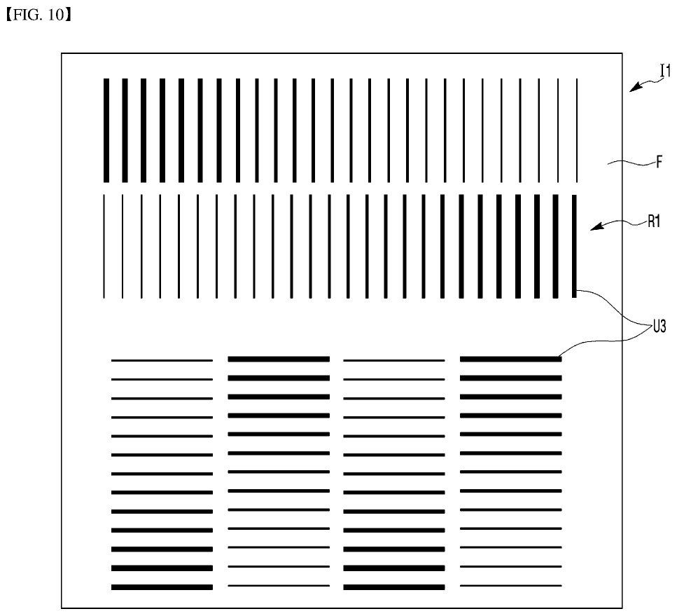

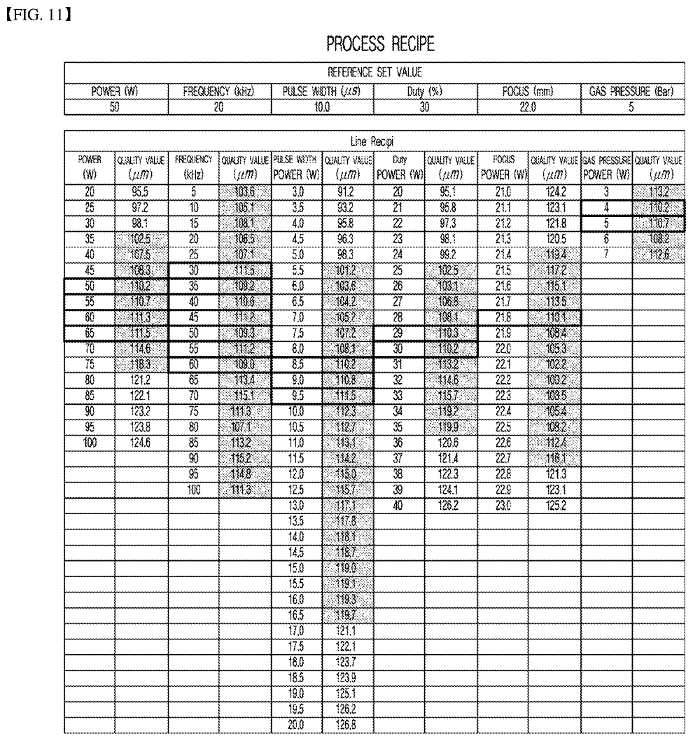

FIG. 10 is a drawing for explaining a method of performing first test cutting processing on a processing target using set values for testing included in a process recipe, and FIG. 11 is a drawing for explaining a method of selecting a set value for mass production among set values for testing included in a process recipe using the results of first test cutting processing.

In step S50, the controller 10 drives the processing machine 30 by selectively using the set values for testing and the default set values included in the process recipe set in step S40 to perform first test cutting processing on the processing target F, the imaging module 80 photographs the results R1 of the first test cutting processing using the camera 82, and the analysis module 90 analyzes a captured image I1 of the results R1 of the first test cutting processing to measure the quality value of a predetermined quality item.

First, the controller 10 individually performs first test cutting processing on each of the processing units U (step S52). More specifically, the first test cutting processing may be individually performed on each of the processing units U through a manner wherein a region of the processing target F positioned at a predetermined processing position by the feed conveyor 24 and the mounting member 26 is irradiated with a laser beam (LB) along a specific section of the cutting line E included in each of the processing units U.

However, some of all processing units U may have the same processing shape. As such, when there is a plurality of processing units U having the same processing shape, first test cutting processing is preferably performed selectively only on any one processing unit U among the processing units U having the same processing shape. For example, as shown in FIG. 10, when all processing units U have the same processing shape and a single process recipe is prepared, first test cutting processing may be selectively performed only on a specific processing unit (e.g., U3) among the processing units U.

In addition, as shown in FIG. 10, first test cutting processing is repeatedly performed in multiple implementation rounds corresponding to the number of set values for testing included in a process recipe. For example, when all processing units U have the same processing shape and a single process recipe is prepared, first test cutting processing for the specific processing unit (e.g., U3) may be repeatedly performed in implementation rounds corresponding to the number of set values for testing included in a process recipe.

In addition, as shown in FIG. 10, first test cutting processing for the specific processing unit (e.g., U3) is preferably performed so that the results R1 of first test cutting processing for the specific processing unit formed on a region of the processing target F positioned at a predetermined processing position are separated from each other by a predetermined interval, but the present disclosure is not limited thereto.

In addition, the controller 10 may use a default set value for each of remaining processing parameters except for a specific processing parameter among processing parameters as the set value of each of the remaining processing parameters, may selectively use any one set value for testing among set values for testing of the specific processing parameter as the set value of the specific processing parameter according to a predetermined order, and may repeatedly perform first test cutting processing in multiple implementation rounds. Accordingly, when the results R1 of the first test cutting processing are analyzed, it may be determined whether change in the set value of the specific processing parameter affects the quality value of a predetermined quality item. Preferably, the first test cutting processing for determining whether change in the set value of the specific processing parameter affects a quality value is repeatedly performed a number of times corresponding to the number of set values for testing of the specific processing parameter included in a process recipe.

For example, as shown in FIG. 11, in a state wherein the set value of each of remaining processing parameters except for power among processing parameters is retained as default set values (frequency: 20 kHz, pulse width: 10.0 μs, duty ratio: 30%, focal length: 22.0 mm, and gas pressure: 5 bar), first test cutting processing for determining whether power affects a quality value may be repeatedly performed 17 times corresponding to the number (17) of set values for testing of power included in a process recipe by incrementally increasing the set value of power by a unit interval of 5 W from a minimum set value of 20 W to a maximum set value of 100 W.

In addition, an order of inputting set values for testing is not particularly limited. For example, the setting module 60 may input any one of the set values for testing of a processing parameter to the controller 10 in ascending order for each implementation round of first test cutting processing.

When first test cutting processing is performed as above, the laser cutting quality of the results R1 of each implementation of the first test cutting processing formed on the processing target F may be determined according to the set value for testing of the specific processing parameter selectively input for each implementation round of the first test cutting processing. Accordingly, when the results R1 of the entire first test cutting processing formed on the processing target F are compared and analyzed, it may be individually determined for each of the processing units U whether change in the set value of each of processing parameters affects the quality value of a predetermined quality item.

The first test cutting processing is preferably performed by individually controlling the set value of each of all processing parameters according to a process recipe, but the present disclosure is not limited thereto. For example, when laser cutting processing is performed, first test cutting processing may be performed by controlling only the set values of some (e.g., power (W) and frequency (kHz)) of processing parameters according to the set values for testing of a process recipe.

Next, the imaging module 80 photographs the results R1 of first test cutting processing formed on the processing target F using the camera 82, and then stores the captured image I1 of the results R1 of the first test cutting processing in the storage module 40 (step S54).

Then, the analysis module 90 analyzes the results of the first test cutting processing based on the captured image I1 of the results R1 of the first test cutting processing photographed by the imaging module 80, and measures the quality value of a predetermined quality item for each of the results R1 of the first test cutting processing (step S56). In addition, the setting module 60 inputs the measured quality value to a corresponding part of a process recipe so that the measured quality value matches a set value for testing used in a specific implementation round of the first test cutting processing, the quality value of which has been measured (step S58).

For example, as shown in FIG. 11, when all processing units U have the same processing shape, when first test cutting processing is selectively performed on the specific processing unit (e.g., U3), the setting module 60 may input, to a corresponding part of a process recipe, the quality value (98.1 μm) of a specific implementation round of the first test cutting processing, in which the set value for testing of power is limited to 30 W, so that the quality value matches the set value for testing (30 W) of power.

Through repetition of the above process, process recipes may be completed by measuring a quality value according to each of set values for testing and then inputting the quality value to a corresponding part of the process recipe.

Next, in step S60, the analysis module 90 selects, as a satisfaction value, each of quality values satisfying reference quality set in step S10 among quality values input in process recipes, and then stores the quality value in the storage module 40 (step S62).

A method of selecting a satisfaction value is not particularly limited.

When a reference quality is a reference quality value, the analysis module 90 may select, as a satisfaction value, each of quality values having an error less than a predetermined first reference error based on a reference quality value among quality values.

When a reference quality is within a range of reference quality values, the analysis module 90 may select, as a satisfaction value, each of quality values within the reference quality range among quality values.

In addition, in a process recipe, each of columns in which a satisfaction value is described is preferably specified by a predetermined method. For example, as shown in FIG. 11, in a process recipe, columns in which satisfaction values are described may be shaded.

Next, the analysis module 90 selects, as excellent values, satisfaction values determined to be excellent in laser cutting quality among satisfaction values, and specifies a set value for testing used in a specific implementation round of first test cutting processing in which a quality value corresponding to the excellent value has been measured and stores the set value in the storage module 40 (step S64).

A method of selecting an excellent value is not particularly limited.

When reference quality is a reference quality value, the analysis module 90 may select, as an excellent value, each of satisfaction values, wherein an error from the reference quality value is less than a second reference error determined to have an absolute value smaller than the first reference error, among satisfaction values.

When a reference quality is within a range of reference quality values, the analysis module 90 may select, as an excellent value, each of satisfaction values, wherein an error from a median of the range of reference quality values is less than a predetermined third reference error. For example, as shown in FIG. 11, when a range of reference quality values is 100 μm to 120 μm and a third reference error is±2 μm, the analysis module 90 may select, as an excellent value, each of satisfaction values within 108 μm to 112 μm having an error of±2 μm based on a median (110 μm) of the range of reference quality values, among satisfaction values.

In addition, in a process recipe, columns in which an excellent value and a set value for testing that match each other are described are preferably specified in a predetermined manner, respectively. For example, as shown in FIG. 11, in a process recipe, each of columns in which an excellent value and a set value for testing that match each other are described may be specified with a box.

Thereafter, among quality values, the analysis module 90 may select, as a set value for mass production, a set value for testing used in a specific implementation round of first test cutting processing, at which a quality value corresponding to an excellent value wherein an error from a reference quality value or a median of a range of reference quality values is the smallest is measured, and then may store the set value for testing in the storage module 40 (step S66). In addition, the analysis module 90 may specify which of processing parameters corresponds to the selected set value for mass production, and may store the selected set value in the storage module 40. For example, as shown in FIG. 11, the analysis module 90 may select, as a set value for mass production for focal length, a set value for testing of 21.8 mm for focal length wherein a quality value of 110.1 μm having the smallest error from the median is measured.

In the case of manufacturing the product P by performing mass production processing on the processing target F, a set value for mass production may be used as the set value of a processing parameter when laser processing is performed on the processing unit U associated with the set value for mass production among all processing units U. However, the present disclosure is not limited thereto. When all processing units U have the same processing shape, when first test cutting processing is selectively performed on a specific processing unit (e.g., U3) among the processing units U, a set value for mass production selected according to the first test cutting processing on the specific processing unit (e.g., U3) may be selected as a common set value for mass production for all processing units U.

A processing parameter associated with a set value for mass production corresponds to a major processing parameter that has a great influence on a quality value. Accordingly, hereinafter, a processing parameter associated with a set value for mass production among all processing parameters is referred to as a target processing parameter, and remaining processing parameters except for the target processing parameter are referred to as normal processing parameters.

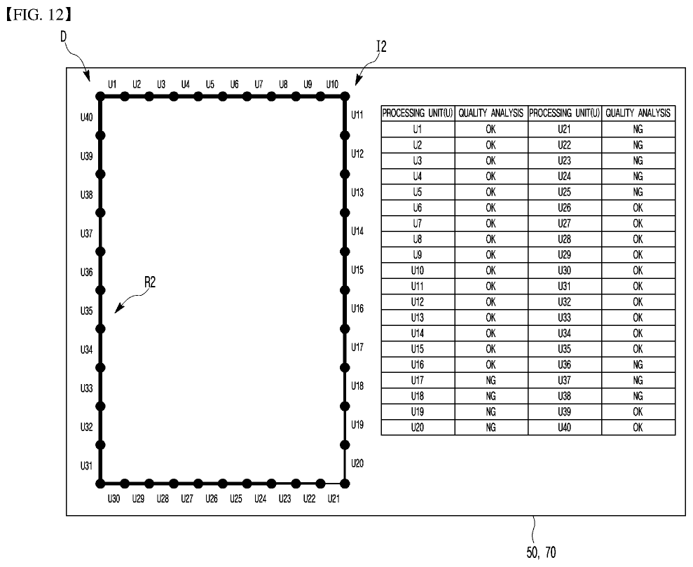

FIG. 12 is a drawing for explaining a method of performing second test cutting processing on a processing target using a set value for mass production selected from a process recipe.

In step S70, the controller 10 drives the processing machine 30 by selectively using the set value for mass production of a target processing parameter selected from a process recipe to perform second test cutting processing on the processing target F, the imaging module 80 photographs the results R2 of the second test cutting processing using the camera 82, and the analysis module 90 analyzes the captured image I2 of the results R2 of the second test cutting processing to measure the quality value of a predetermined quality item.

First, as shown in FIG. 12, the controller 10 continuously radiates a laser beam (LB) onto a region of the processing target F positioned at a predetermined processing position along the entire section of the cutting line E using the processing machine 30. In this case, for a section that belongs to a specific processing unit U among all sections of the cutting line E, the controller 10 may selectively drive the processing machine 30 according to the set value for mass production of a target processing parameter selected from a process recipe for the specific processing unit U to continuously perform second test cutting processing on all processing units U (step S72). That is, the second test cutting processing is performed by continuously radiating a laser beam (LB) along the entire section of the cutting line E so that the product P is formed from the processing target F, and the second test cutting processing is continuously performed on all processing units U. For a specific processing unit U currently being subjected to laser cutting processing among all processing units U, the processing machine 30 is driven by selectively using the set value for mass production of a target processing parameter selected from a process recipe for the specific processing unit U. However, the present disclosure is not limited thereto. When all processing units U have the same processing shape, second test cutting processing may be performed on all processing units U by driving the processing machine 30 in the same pattern by selectively using the set value for mass production of a common target processing parameter selected for all processing units U from a single process recipe according to the first test cutting processing.

A method of performing second test cutting processing by driving the processing machine 30 by selectively using the set value for mass production of a target processing parameter is not particularly limited.

For example, when a process recipe is individually prepared for each of the processing units U, when second test cutting processing is performed on the specific processing unit U among the processing units U, the controller 10 may use, as the set value of a target processing parameter, the set value for mass production selected from a process recipe for the specific processing unit U, and may use, as the set values of normal processing parameters, the default set values of normal processing parameters included in a process recipe for the specific processing unit U.

For example, when all processing units U have the same processing shape and a single process recipe is prepared, when second test cutting processing is performed on all processing units U, the controller 10 may use, as the set value of a target processing parameter, a common set value for mass production selected from the single process recipe, and may use, as the set values of normal processing parameters, the default set values of normal processing parameters included in the single process recipe.

Thereby, the controller 10 may perform second test cutting processing on all processing units U by selectively driving the processing machine 30 and the other components of the laser cutting system 1 by using the set value for mass production of a target processing parameter and the default set value of each of normal processing parameters.

Next, the imaging module 80 photographs the results R2 of the second test cutting processing formed on the processing target F using the camera 82, and then stores the captured image I2 of the results R2 of the second test cutting processing in the storage module 40 (step S74).

Thereafter, the analysis module 90 divides the captured image I2 of the results R2 of the second test cutting processing for each of the processing units U and analyzes the divided captured image I2 to individually measure the quality value of a predetermined quality item for each of the processing units U (step S76).

In step S80, the analysis module 90 determines whether each of the processing units U is defective based on analysis of the results R2 of the second test cutting processing collected in step S70.

Whether each of the processing units U is defective may be determined by individually determining whether the quality value of each of the processing units U measured in step S76 satisfies reference quality.

For example, when reference quality is a reference quality value, the analysis module 90 may compare the quality value of each of the processing units U with the reference quality value. Then, among all processing units U, for the processing units U that have an error between a quality value and a reference quality value, wherein the error is less than or equal to a predetermined reference error, the analysis module 90 may judge laser cutting quality for a predetermined quality item as good (OK). In addition, among all processing units U, for the processing units U that have an error between a quality value and a reference quality value, wherein the error exceeds the predetermined reference error, the analysis module 90 may judge laser cutting quality for a predetermined quality item as defective (NG).

For example, when reference quality is within a reference quality range, the analysis module 90 may compare the quality value of each of the processing units U with a reference quality range. Then, for the processing units U having a quality value within the reference quality range among all processing units U, the analysis module 90 may judge laser cutting quality for a predetermined quality item as good (OK). In addition, for the processing units U (e.g., U17 to U25, U36 to U38) having a quality value outside the reference quality range among all processing units U, the analysis module 90 may judge laser cutting quality for a predetermined quality item as defective (NG).

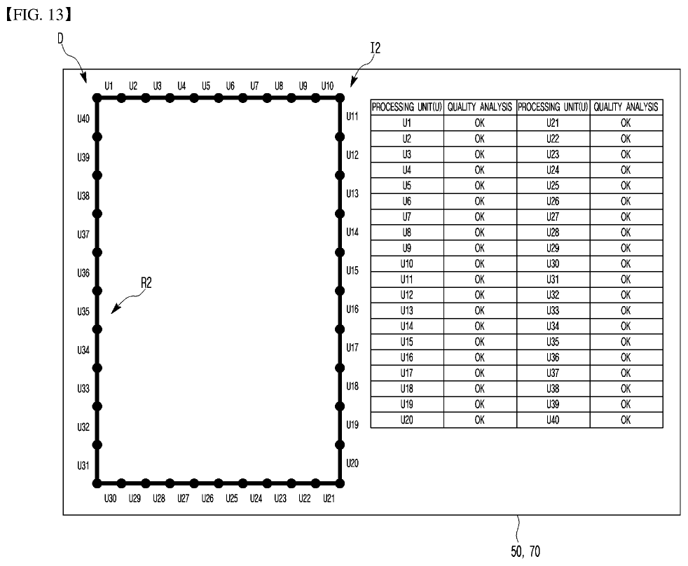

FIG. 13 is a drawing for explaining a method of performing second test cutting processing once more using a set value for mass production reselected according to the results of second test cutting processing.

When there are processing units (e.g., U17 to U25, U36 to U38) judged to be defective among the processing units U upon second test cutting processing, set values for mass production for the processing units (e.g., U17 to U25, U36 to U38) may be reselected (step S66).

For example, among remaining excellent values except for an excellent value matching a set value for testing previously selected as a set value for mass production, the analysis module 90 may reselect, as a new set value for mass production for the processing units U judged to be defective, a set value for testing matching an excellent value having the smallest error based on a reference quality value or a median of a range of reference quality values. That is, among quality values input in a process recipe, the analysis module 90 may reselect, as a new set value for mass production for the processing units U judged to be defective, a set value for testing matching an excellent value satisfying reference quality as the next order of an excellent value matching a set value for testing previously selected as a set value for mass production. Thereby, for the processing units U judged to be defective, the analysis module 90 may replace an existing set value for mass production with a new set value for mass production.

According to reselection of a set value for mass production, in the case of mass production of the product P, laser cutting processing may be performed on the processing target F according to a set value for mass production individually selected for each of the processing units U according to the features of the processing target F and the fixing jigs 100. Thereby, the laser cutting system 1 may prevent the laser processing quality of the processing target F from varying for each area of the processing target F due to various causes such as a variation in thickness of the processing target F and a variation in flatness of the fixing jigs 100, thereby improving the laser processing quality of the processing target F.

In addition, when reselecting a set value for mass production for the processing units U judged to be defective, a set value for mass production for the remaining processing units U judged to be good among the processing units U is preferably retained, but the present disclosure is not limited thereto.

In addition, step S72 of performing second test cutting processing using the reselected set value for mass production, step S74 of photographing the results R2 of the second test cutting processing, step S76 of analyzing the results R2 of the second test cutting processing and measuring the quality value of the predetermined quality item for each of the processing units U, and step S80 of judging whether each of the processing units U is defective may be performed again sequentially.

As a result of defect judgment, when all processing units U are judged to be good, operation of selecting a set value for mass production for all processing units U is completed. The set value for mass production that has been selected may be used as driving data for keeping the quality value of a predetermined quality item at a reference quality level when laser processing is performed on the processing target F to manufacture a product in large quantities.

As a result of defect judgment, when some of the processing units U are still judged to be defective, step S66 of reselecting a set value for mass production, step S72 of performing second test cutting processing, step S74 of photographing the results R2 of the second test cutting processing, step S76 of analyzing the results R2 of the second test cutting processing and measuring the quality value of a predetermined quality item for each of the processing units U, and step S80 of judging whether each of the processing units U is defective may be performed again sequentially.

Conventionally, to improve laser cutting quality, an operator had to manually select the set values for mass production of processing parameters to be applied to mass production of a product by repeatedly performing test cutting processing while manually controlling the set values of processing parameters depending on experience.

Accordingly, conventionally, a large amount of time and a large number of operators were required to manually select the set values for mass production of processing parameters to be applied to mass production of a product. Thus, there was a problem in that the laser cutting quality of a processing target was influenced by the skill level of an operator who selected the set values for mass production of processing parameters.

However, according to the laser cutting system 1, the set values for mass production of processing parameters may be automatically selected. Accordingly, when the laser cutting system 1 is used, time and the number of operators required to select the set values for mass production of processing parameters may be reduced. In addition, regardless of the operator's skill level, the set values for mass production of processing parameters may be accurately selected according to processing conditions, thereby improving the laser cutting quality of the processing target F.

In addition, preferably, operation of selecting a set value for mass production described above is repeatedly performed. For example, when predetermined processing time elapses from the time when operation of selecting a set value for mass production was previously performed, operation of selecting a set value for mass production may be repeatedly performed whenever predetermined selection conditions are satisfied, such as when a laser processing device is powered on. Data about the set value for mass production repeatedly selected in this way may be stored in the storage module 40 in an accumulative manner. Then, when operation of selecting a set value for mass production is performed, using existing data about operation of selecting a set value for mass production accumulated in the storage module 40, the number of set values for testing included in a process recipe may be reduced, or a minimum set value, a maximum set value, and a default set value may be accurately set. Thereby, the laser cutting system 1 may reduce time and the number of operators required to perform operation of selecting a set value for mass production, and may accurately select a set value for mass production according to processing conditions, thereby further improving the laser cutting quality of the processing target F.

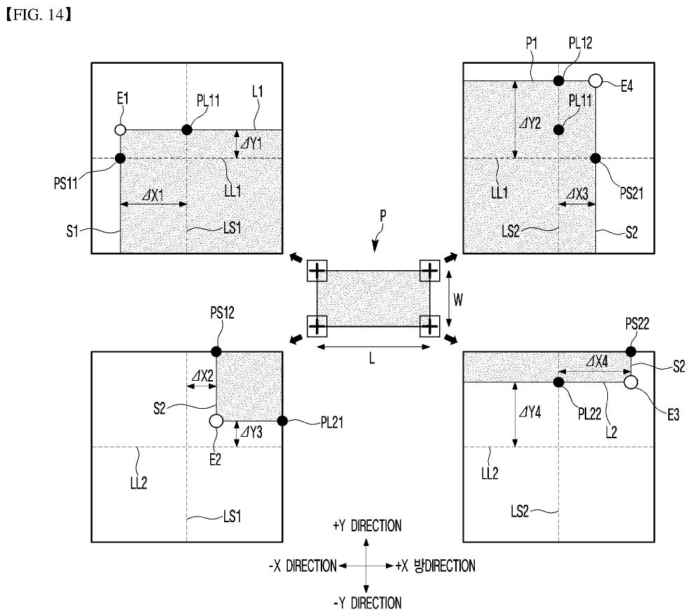

FIG. 14 is a drawing for explaining a method of obtaining the dimension information and angle information of a product.

As described above, the camera 82 of the imaging module 80 is coupled to the slider 34a of the conveying member 34 to which the laser head 32 is coupled, so that the camera 82 and the laser head 32 are conveyed by the conveying member 34 along the same path. Accordingly, as shown in FIG. 14, the imaging module 80 may obtain, using the camera 82, images of the outline (including long sides, short sides, and corners) of the product P formed by laser-cutting the processing target F. The analysis module 90 may analyze the images to measure lengths W of short sides S1 and S2 of the product P and lengths L of long sides L1 and L2 of the product P, distances ΔX1, ΔX2, ΔX3, and ΔX4 between predetermined measurement points PS11, PS12, PS21, and PS22 of the short sides S1 and S2 of the product P and predetermined reference lines LS1 and LS2, distances ΔY1, ΔY2, ΔY3, and ΔY4 between predetermined measurement points PL11, PL12, PL21, and PL22 of the long sides L1 and L2 of the product P and predetermined reference lines LL1 and LL2, and the locations of corners E1, E2, E3, and E4 of the product P.

In addition, the analysis module 90 may compare the distances ΔX1 and ΔX2 between the measurement points PS11 and PS12 positioned at the short side S1 and the reference line LS1 to measure the angle between the short side S1 and the Y-axis. In addition, the analysis module 90 may compare the distances ΔY1 and ΔY2 between the measurement points PL11 and PL12 positioned at the long side L1 and the reference line LL1 to measure the angle between the long side L1 and the X-axis.

In addition, the analysis module 90 may compare the angle between the short side S1 and the Y-axis and the angle between the long side L1 and the X-axis to measure the angle of a corner E1 where the short side S1 and the long side L1 meet, i.e., the perpendicularity of the product P. Whenever the product P is manufactured by performing laser cutting processing on the processing target F, the analysis module 90 may store, in the storage module 40, dimension data and angle data about the product P measured in the above manner

In addition, the analysis module 90 may check change in the distribution of the product P based on dimension data and angle data about the product P accumulated in the storage module 40. Thus, using dimension data and angle data about the previously manufactured product P, the laser cutting system 1 may correct, in real time, data about manufacture of the product P to be manufactured. Accordingly, when the laser cutting system 1 is used, error rate may be reduced, and the manufacturing history of the product P may be effectively managed.

The present disclosure relates a laser cutting system and a laser cutting method. According to the present disclosure, test cutting processing is performed on a processing target in various manners using a process recipe in which the set values for testing of each of processing parameters for controlling the quality values of quality items representing the laser cutting quality of the processing target are automatically prepared according to processing conditions, such as the processing design of the processing target, and then the results of test cutting processing are analyzed to automatically select the set value for mass production of processing parameters for application to mass production of a product. Accordingly, time and the number of operators required to perform operation of selecting the set value for mass production of processing parameters can be reduced. In addition, regardless of the operator's skill level, the set value for mass production of processing parameters can be accurately selected according to processing conditions, thereby improving the laser cutting quality of the processing target.

Although the present disclosure has been described through limited examples and figures, the present disclosure is not intended to be limited to the examples. Those skilled in the art will appreciate that various modifications, additions, and substitutions are possible, without departing from the scope and spirit of the invention.

Therefore, the embodiments disclosed in the present disclosure are intended to describe the technical idea of the present disclosure, and the scope of the technical idea of the present disclosure is not limited by these embodiments. The scope of protection of the present disclosure should be defined by the following claims, and all technical ideas within the scope of protection should be construed as being included in the scope of the present disclosure.

### DESCRIPTION OF SYMBOLS

1: LASER CUTTING SYSTEM

10: CONTROLLER

20: FEEDER

22: FEED ROLLERS

24: FEED CONVEYOR

26: MOUNTING MEMBER

30: PROCESSING MACHINE

32: LASER HEAD

34: CONVEYING MEMBER

34a: SLIDER

34b: FIRST CONVEYING MEMBER

34c: SECOND CONVEYING MEMBERS

40: STORAGE MODULE

50: INPUT MODULE

60: SETTING MODULE

70: DISPLAY MODULE

80: IMAGING MODULE

82: CAMERA

90: ANALYSIS MODULE

100: FIXING JIGS

110: TRANSFER UNIT

112: GRIPPING MEMBER

112a: BASE PLATE

112b: VACUUM ADSORPTION PADS

114: CONVEYING MEMBER

120: EJECTOR

130: STACKER

132: WHEELS

F: PROCESSING TARGET

D: PROCESSING DESIGN

E: CUTTING LINE

U: PROCESSING UNIT

LB: LASER BEAM

P: PRODUCT

What is claimed is:

1. A laser cutting system, comprising:
a processing machine provided to perform laser cutting on a processing target using a laser beam according to a predetermined processing design to divide the processing target to form a product having a shape corresponding to the processing design;
a setting module for preparing, according to predetermined processing conditions, a process recipe comprising a plurality of set values for testing of processing parameters that affect a quality value of laser cutting processing;
a controller for repeatedly performing first test cutting processing on the processing target in multiple implementation rounds by driving the processing machine by selectively using any one of the set values for testing as a set value of the processing parameters according to a predetermined order; and
an analysis module for analyzing each of results of the first test cutting processing and individually measuring a quality value of each of the results of the first test cutting processing, and selecting, among the set values for testing, a set value for testing used in a specific implementation round of the first test cutting processing, at which the quality value that most satisfies predetermined reference quality is measured, as a set value for mass production of the processing parameters.

2. The laser cutting system according to claim 1, further comprising an input module provided to input at least one of the processing design and the reference quality.

3. The laser cutting system according to claim 2, wherein the setting module sets the set values for testing according to predetermined setting criteria,
wherein the setting criteria comprise a minimum set value that is a smallest absolute value among the set values for testing, a maximum set value that is a largest absolute value among the set values for testing, and a unit interval of the set values for testing.

4. The laser cutting system according to claim 3, wherein the input module is provided to input at least one of the minimum set value, the maximum set value, and the unit interval.

5. The laser cutting system according to claim 1, wherein, when the reference quality is a reference quality value, the analysis module selects, among the set values for testing, a set value for testing used in a specific implementation round of the first test cutting processing, at which the quality value having a smallest error based on the reference quality value is measured, as the set value for mass production, and
when the reference quality is within a reference quality range, the analysis module selects, among the set values for testing, a set value for testing used in a specific implementation round of the first test cutting processing, at which the quality value having a smallest error based on a median of the reference quality range is measured, as the set value for mass production.

6. The laser cutting system according to claim 1, wherein, when a rectangular product having a predetermined width and length is manufactured, a processing shape of the processing design is defined by a cutting line forming a rectangular closed loop that matches an outline of the product,
the setting module divides the processing design into a plurality of processing units each comprising any one of a plurality of unit linear sections constituting the cutting line,
the controller selectively performs first test cutting processing on a specific processing unit among the processing units, and
the analysis module analyzes results of the first test cutting processing for the specific processing unit and selects a common set value for mass production for the processing units.

7. The laser cutting system according to claim 6, wherein the controller drives the processing machine by selectively using the common set value for mass production for the processing units to perform second test cutting processing on the processing units, and
the analysis module analyzes results of the second test cutting processing for each of the processing units, individually measures a quality value for each of the processing units, and individually determines whether each of the processing units is defective.

8. The laser cutting system according to claim 7, wherein the analysis module determines that a processing unit having a quality value satisfying the reference quality among the processing units is good, and determines that a processing unit having a quality value that does not satisfy the reference quality among the processing units is defective.

9. The laser cutting system according to claim 8, wherein the analysis module reselects a new set value for mass production from the process recipe for the processing unit that has been determined to be defective among the processing units, and
the controller applies the new set value for mass production to the processing unit determined to be defective, instead of the previously selected set value for mass production, and performs the second test cutting processing on the processing units again.

10. The laser cutting system according to claim 9, wherein the setting module inputs a quality value of each of results of the first test cutting processing to the process recipe so that the quality value matches the set value for testing used at a specific implementation round of the first test cutting processing at which the quality value is measured, and
when there is the processing unit that has been determined to be defective, the analysis module reselects, as the new set value for mass production for the processing unit that has been determined to be defective, a quality value satisfying reference quality as a next rank of a quality value matching a set value for testing previously selected as the set value for mass production among the quality values.

11. The laser cutting system according to claim 8, wherein the setting module prepares the process recipe so that a set value for testing of each of a plurality of processing parameters for controlling the quality value is individually comprised.

12. The laser cutting system according to claim 11, wherein, when the first test cutting processing is performed, for each of remaining processing parameters except for a specific processing parameter among the processing parameters, the controller uses a predetermined default set value as a set value of each of the remaining processing parameters, and selectively uses any one set value for testing among set values for testing of the specific processing parameter as a set value of the specific processing parameter, and
the analysis module identifies which of the processing parameters is associated with the set value for mass production when results of the first test cutting processing are analyzed and the set value for mass production is selected.

13. The laser cutting system according to claim 11, wherein, when the second test cutting processing is performed, the controller uses the set value for mass production as a set value of a specific processing parameter associated with the set value for mass production among the processing parameters, and uses a predetermined default set value of each of the remaining processing parameters as a set value of each of remaining processing parameters except for the specific processing parameter.
